(19) United States
(12) Patent Application Publication
(10) Pub. No.: US 2026/0184223 A1
(43) Pub. Date: Jul. 2, 2026

(54) METHOD AND SYSTEM FOR PROVIDING ENERGY TO VEHICLES USING SECURE CREDENTIAL TRANSFER

(71) Applicant: Visa International Service Association, San Francisco, CA (US)

(72) Inventors: Brian Sullivan, San Francisco, CA (US); Gregory Miller, San Francisco, CA (US)

(73) Assignee: Visa International Service Association, San Francisco, CA (US)

(21) Appl. No.: 19/127,679

(22) PCT Filed: Nov. 14, 2022
(86) PCT No.: PCT/US2022/049839

§ 371 Date: May 6, 2025

(51) Int. Cl. B60L 53/66; G06Q 20/32; G06Q 20/38; G06Q 20/40

(52) U.S. Cl. CPC B60L 53/665; G06Q 20/327; G06Q 20/3821; G06Q 20/401

(57) ABSTRACT

A method is disclosed. The method includes receiving, by a user device from an energy supply terminal, transaction data comprising an energy provider identifier for a transaction to provide energy from the energy supply terminal to a vehicle. The user device then determines a credential, and then transmits the energy provider identifier and a selection of the credential to a secure remote transaction server. The secure remote transaction server initiates transmission of an authorization request message comprising the energy provider identifier, the credential or a token corresponding to the credential, and an amount to an authorizing entity computer. The secure remote transaction server then receives an authorization response message for the transaction from the authorizing entity computer. The secure remote transaction server can also provide an indication of the authorization for the transaction the user device.

### CROSS-REFERENCES TO RELATED APPLICATIONS

None.

### BACKGROUND

Various methods have been developed to provide energy to vehicles. Such methods often require a user to provide a credential to an energy supply terminal. For example, to purchase gasoline from a gasoline supply terminal (e.g., a gas pump) or to purchase electricity from an electric power terminal, the user needs to provide a secure credential such as a credit or debit card number to the terminal.

Providing the secure credential to the energy supply terminal increases the risk that the secure credential can be stolen by an unauthorized user. For example, some unauthorized users can put skimmers on card readers at the energy supply terminals, and/or can intercept wireless data transmissions between an authorized user device and the energy supply terminal. Further, hackers can hack into the energy supply terminals to obtain the secure credentials. Still further, unscrupulous employees that may have access to the secure credentials can also steal the secure credentials obtained by the energy supply terminals.

Another problem that is present is that there can be many different energy supply terminals. As more and more payment methods become available, each energy supply terminal needs to be specifically programmed or adapted to process the different payment methods. This situation can be difficult to implement and maintain. Still further, if secure credentials are received at an energy supply terminal, the energy supply terminal needs to be PCI-DSS (payments card industry-data security standard) complaint. Maintaining such security compliance across many different types of energy supply terminals is also difficult to implement and maintain.

Another problem is that the current charging infrastructure needs to keep up with continued demand for electric vehicles. The number of electric charging stations needs to increase. Conventional electric charging stations often need expensive components (e.g., card readers) and specialized software (e.g., cryptographic keys to sure payment data) to process payment transactions.

Embodiments of the invention address these and other problems, individually and collectively.

### SUMMARY

One embodiment of the disclosure includes a method comprising: receiving, by a user device from an energy supply terminal, transaction data comprising an energy provider identifier for a transaction to provide energy from the energy supply terminal to a vehicle; determining, using the user device, a credential; transmitting, by the user device to a secure remote transaction server, the energy provider identifier and a selection of the credential, wherein the secure remote transaction server initiates transmission of an authorization request message comprising the energy provider identifier, the credential or a token corresponding to the credential, and an amount; and receiving, by the user device from the secure remote transaction server, a message indicating authorization for the transaction.

Another embodiment of the disclosure includes a user device comprising: a processor; and a non-transitory computer readable medium, the non-transitory computer readable medium comprising code, executable by the processor for performing operations comprising: receiving, from an energy supply terminal, transaction data comprising an energy provider identifier for a transaction to provide energy from the energy supply terminal to a vehicle; determining a credential; transmitting, to a secure remote transaction server, the energy provider identifier and a selection of the credential, wherein the secure remote transaction server initiates transmission of an authorization request message comprising the energy provider identifier, the credential or a token corresponding to the credential, and an amount; and receiving, from the secure remote transaction server, a message indicating authorization for the transaction.

Another embodiment of the disclosure can include a method comprising: providing, by an energy supply terminal to a vehicle, transaction data comprising an energy provider identifier for a transaction to provide energy from the energy supply terminal to the vehicle, which provides the transaction data to a user device, and then to a secure remote transaction server, wherein the secure remote transaction server initiates transmission of an authorization request message comprising the energy provider identifier, a credential or a token corresponding to the credential, and an amount; receiving, by the energy supply terminal, an indicator message from a terminal support computer after the secure remote transaction server initiates the transmission of the authorization request message; and responsive to receiving the indicator message, providing the energy to the vehicle.

Another embodiment of the disclosure can include an energy supply terminal comprising: a processor; and a non-transitory computer readable medium coupled to the processor, the non-transitory computer readable medium comprising code executable by the processor for performing a method comprising providing, to a vehicle, transaction data comprising an energy provider identifier for a transaction to provide energy from the energy supply terminal to the vehicle, which provides the transaction data to a user device, and then to a secure remote transaction server, wherein the secure remote transaction server initiates transmission of an authorization request message comprising the energy provider identifier, a credential or a token corresponding to the credential, and an amount, receiving an indicator message from a terminal support computer after the secure remote transaction server initiates the transmission of the authorization request message; and responsive to receiving the indicator message, providing the energy to the vehicle.

These and other embodiments are described in further detail below.

### BRIEF DESCRIPTION OF THE DRAWINGS

FIG. 1 shows a block diagram of a system with an overlaid process flow according to embodiments.

FIG. 2 shows a block diagram of a vehicle with some components according to embodiments.

FIG. 3 shows a block diagram of an energy supply terminal according to embodiments.

FIG. 4 shows a block diagram of an exemplary user device according to embodiments.

FIG. 5 shows a block diagram of an exemplary secure remote transaction server according to embodiments.

### DETAILED DESCRIPTION

Prior to discussing embodiments of the invention, description of some terms may be helpful in understanding embodiments of the invention.

A “user” may include an individual or a computational device. In some embodiments, a user may be associated with one or more personal accounts and/or mobile devices. In some embodiments, the user may be a cardholder, account holder, or consumer.

A “user device” may be any suitable device that can be used by a user to accomplish a function desired by the user. User devices may be in any suitable form. Some examples of user devices include mobile devices such as mobile phones (e.g., cellular phones), PDAs, personal computers (PCs), tablet computers, wearable devices such as smartwatches, rings, glasses, and bracelets, and the like.

A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as automobiles and motorcycles, personal music players, hand-held specialized readers, etc.

“Authentication data” may include any data suitable for authenticating a user or mobile device. Authentication data may be obtained from a user or a device that is operated by the user. Examples of authentication data obtained from a user may include PINs (personal identification numbers), biometric data, passwords, etc. Examples of authentication data that may be obtained from a device may be include device serial numbers, hardware secure element identifiers, device fingerprints, phone numbers, IMEI numbers, etc.

An “electronic wallet” or “digital wallet” can include an electronic device that allows an individual to conduct electronic commerce transactions. A digital wallet may store user profile information, credentials, bank account information, one or more digital wallet identifiers and/or the like and can be used in a variety of transactions, such as, but not limited to, eCommerce transactions, social network transactions, money transfer/personal payment transactions, mobile commerce transactions, proximity payment transactions, gaming transactions, etc. A digital wallet may be designed to streamline the purchase and payment process. A digital wallet may allow the user to load one or more payment cards onto the digital wallet so as to make a payment without having to enter an account number or present a physical card.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes, and other login information, etc. Other examples of credentials include PANs (primary account numbers), PII (personal identifiable information) such as name, address, and phone number, and the like.

An “authorizing entity” may be an entity that authorizes a request, typically using an authorizing entity computer. An authorizing entity may be an issuer, a governmental agency, a document repository, an access administrator, etc. An “issuer” may typically include a business entity (e.g., a bank) that maintains an account for a user. An issuer may also issue payment credentials to the user. The credentials may be stored in the cloud or on a user device, such as a cellular telephone, smart card, tablet, or laptop of the user.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle, or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

A “key” may include a piece of information that is used in a cryptographic algorithm to transform data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” is typically a powerful computer or cluster of computers. For example, the server computer can be a large mainframe, a minicomputer cluster, or a group of servers functioning as a unit. In one example, the server computer may be a database server coupled to a Web server.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

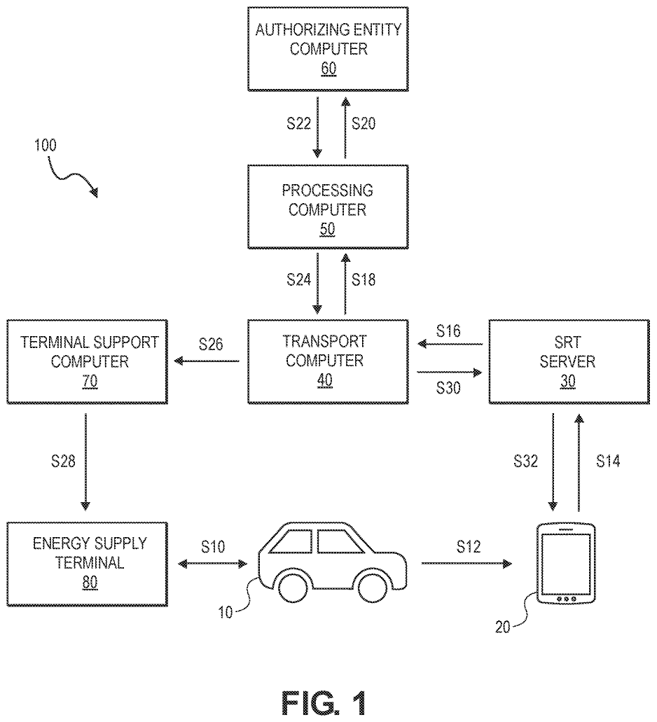

FIG. 1 shows a system 100 according to embodiments of the invention. The system 100 can be used to provide energy to a vehicle 10 by an energy supply terminal 80, while keeping sensitive data such as credentials or tokens from the energy supply terminal 80 and its corresponding terminal support computer 70. As such, the sensitive data cannot be obtained by unauthorized persons that may have access to the terminal support computer 70 and the energy supply terminal 80. Further, the terminal support computer 70 and the energy supply terminal 80 do not need to be PCI-DSS complaint and do not need to be updated with specialized software for many different types of payment methods since they do not receive or process the sensitive data.

FIG. 1 shows a vehicle 10 that can receive energy from an energy supply terminal 80. An energy connector such as a charging cable or a gasoline hose can temporarily couple the energy supply terminal 80 to the vehicle 10 while the vehicle 10 receives energy from the energy supply terminal 80.

The vehicle 10 can be any suitable mode of transportation that runs on energy. Examples of vehicles can include electric or gasoline powered cars, boats, scooters, bicycles, air taxis, etc.

The energy supply terminal 80 may also be in communication with a terminal support computer 70. The energy supply terminal 80 may be one of a plurality of energy supply terminals that is operated by an energy supplier operating the terminal support computer 70.

The vehicle 10 can have or be in communication with a user device 20. The user device 20 can be a mobile phone operated by a user of the user device 20, or it may be a separate hardware element in the vehicle 10.

The user device 20 can have an application such as a digital wallet application, which can allow the user device 20 to communicate with the SRT (secure remote transaction) server 30. In some embodiments, the SRT server 30 can be characterized as an application server for the digital wallet application.

The SRT server 30 can include a computer that can process transactions and/or store credentials or tokens. In some embodiments, upon selection of an account by a user of the user device 20, the user device 20 or an initiator server in communication with the mobile device, and the SRT server 30 may communicate the selection to the SRT server. In some embodiments, the SRT server 30 may then identify one or more facilitator applications that support authentication of the selected account and are installed on the user device 20. In some embodiments, the list may also be provided to the user device 20 for selection by the user. The facilitator application may subsequently perform an authentication process to request authentication data from the user and/or user device 20 to verify the identity of the user of the user device 20. Once authenticated, the facilitator application may provide an authentication indicator back to the SRT server 30. Upon receiving this authentication indicator, the SRT server 30 may obtain a token or credential associated with the selected account, and can generate an authorization request message as described below.

The SRT server 30 can also be in communication with a transport computer 40. The transport computer 40 can be operated by an entity such as an acquirer. An acquirer can hold an account of an energy supply organization or company that operates the terminal support computer 70 and the energy supply terminal 80.

The transport computer 40 may be in communication with an authorizing entity computer 60 via a processing computer 50. The transport computer 40 may also be in communication with the terminal support computer 70.

The processing computer 50 can be a computer in a computer network such as a payment processing network. The payment processing network may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system), which processes authorization requests and a Base II system which performs clearing and settlement services. The payment processing network may use any suitable wired or wireless network, including the Internet.

The authorizing entity computer 60 can be operated by an entity such as an issuer that holds an account of the user operating the user device 20. The authorizing entity computer 60 can include a processor and a computer readable medium coupled to the processor, the computer readable medium comprising code, executable by the processor for performing the functions described below.

The entities in FIG. 1 may communicate through any suitable communication channel and/or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Methods according to embodiments of the invention can now be described in further detail. One embodiment of the disclosure includes a method comprising receiving, by a user device from an energy supply terminal, transaction data comprising an energy provider identifier for a transaction to provide energy from the energy supply terminal to a vehicle. The user device then determines a credential, and then transmits the energy provider identifier and a selection of the credential to a secure remote transaction server. The secure remote transaction server initiates transmission of an authorization request message comprising the energy provider identifier, the credential or a token corresponding to the credential, and an amount to an authorizing entity computer. The secure remote transaction server then receives an authorization response message for the transaction from the authorizing entity computer. The secure remote transaction server can also provide the authorization response message to the user device. Further details regarding the methods can be described below.

In step S10, a user of the user device 20 has an intent to fill the user's vehicle 10 with energy such as electricity using the energy supply terminal 80. A display on the energy supply terminal 80 can show the cost of the energy to be supplied (e.g., price per kW/hour, price per gallon of gasoline, etc.). The user of the user device 20 uses an energy conduit such as a charging cable, a gasoline hose and nozzle, or similar device which is part of the energy supply terminal 80 to temporarily connect the vehicle 10 to the energy supply terminal 80. Transaction data including an energy provider identifier (e.g., an energy provider identification number and/or energy provider name) and optionally an amount and a session ID (e.g., a correlation ID or transaction ID) can be provided by the energy supply terminal 80 to the vehicle 10 via the energy conduit. Other transaction data that may be provided by the energy supply terminal 80 to the vehicle 10 can include a transport computer ID such as an acquirer ID. The transaction data that is provided from the energy supply terminal 80 to the vehicle 10 can be secured through a data protection mechanism such as JWS (JSON Web Signature).

In some embodiments, the energy supply conduit can use a communication standard such as ISO 15118 to communicate with the vehicle 10. ISO 15118 is an international standard that defines the communications protocol between the charging station and the electric vehicle, whether using AC, DC, wireless, or pantograph charging.

In some embodiments, if an amount is determined by the energy supply terminal 80, then the energy supply terminal 80 may provide a pre-authorization amount that is in excess of the cost of the energy needed to completely fill the vehicle from empty. For example, an amount of one hundred dollars may be a sufficient amount of money to charge the vehicle 10 with electricity if the vehicle 10 is empty (i.e., has no electric charge stored). The amount of one hundred dollars may be a pre-authorization amount, and an authorization request message comprising the pre-authorization amount can be sent to an authorizing entity computer. After authorizing the pre-authorization amount, the authorizing entity computer can place a hold on an account of the user. At a later time, the actual transaction amount for the actual amount of energy obtained by the vehicle 10 can be determined after the user has disconnected the energy supply conduit from the vehicle 10. A subsequent authorization request message for the actual amount of the energy obtained will be transmitted to the authorizing entity computer 60 and approved, or the actual amount of the transaction may be processed during a clearing and settlement process. The pre-authorization hold will be released after the transaction is settled at a later time for the actual transaction amount.

In other embodiments, an authorization request message without a pre-authorization amount can be sent to the authorizing entity computer 60. In some embodiments, the user of the user device 20 can specify how much energy is desired. For example, the user of the user device 20 can input the desired amount of energy or the amount that the user is willing to pay directly into the energy supply terminal 80. Alternatively, the user may input the desired amount of the energy or the amount that the user is willing to pay into a user interface in the vehicle 10 or the user device 20 when they are in communication with the energy supply terminal 80. The vehicle 10 can then provide the user input information to the energy supply terminal 80 via the energy conduit connecting the vehicle 10 and the energy supply terminal 80.

In step S12, after the vehicle 10 receives the transaction data from the energy supply terminal 80, the transaction data is passed from the vehicle 10 to the user device 20. The transfer of transaction data can occur using any suitable data transfer mechanism including but not limited to a QR code which is presented by a display in the vehicle 10 and is scanned by the user device 20, Bluetooth, WiFi™, NFC™, a direct electrical connection, etc. In some embodiments, the user device 20 or the vehicle 10 can show the user the expected cost for supplying the energy, and the user can indicate approval to proceed to either the user device 20 and/or the vehicle 10.

After the user device 20 receives the transaction data from the vehicle 10, the user device 20 can determine a credential. For example, the user device 20 can determine a credential by presenting the user with a list of possible credentials to use to conduct the current energy supply transaction. The list may include a list of the last four digits of the account numbers of accounts held by the user. The user can then select the desired credential from the list of possible credentials, and the user device 20 can also consequently determine the credential based on the user selection. In other embodiments, the user device 20 can automatically determine the credential if the user of the user device 20 previously expressed a preference of one credential over other credentials.

In some embodiments, the user device 20 may have an application such as a digital wallet application that is associated with the SRT server 30. In some embodiments, the SRT server 30 can be invoked by the detection of the energy supply terminal 80 being connected to the vehicle 10, when the user device 20 is in communication with the vehicle 10. The application can also display the name of the energy provider, a location of the energy supply terminal 80, and any other data associated with the transaction (e.g., a transaction currency, a charge status, a charge amount, a date and time stamp, etc.) to the user. In some cases, the digital wallet application can also prompt the user to enter or confirm a transaction amount for the transaction in addition to selecting a credential with which to conduct the transaction.

In step S14, the transaction data and a selection of a credential is provided to the SRT server 30. The selection of the credential by the user device 20 can be in the form of an indication associated with the selected credential. The indication could be in the form of the credential itself, a token corresponding to the credential, a credential reference identifier associated with the credential, or a token reference identifier associated with the token.

In step S16, the SRT server 30 initiates transmission of an authorization request message. The SRT server 30 can do so by generating an authorization request message and transmitting it to the transport computer 40. The SRT server 30 and the transport computer 40 can communicate via one or more APIs or through any other suitable interface. As noted above, the transport computer ID may be present in the transaction data. The authorization request message can include at least the credential or a token associated with the credential, the session ID, and a transaction amount. It may also include any of the other data elements in the “authorization request message” described above.

In some embodiments, the SRT server 30 receives a reference identifier for the credential or the token, but not the actual credential or token from the user device 20. The actual credential or token is stored at the SRT server 30 in a database on behalf of the user of the user device 20. The actual credential or token can be retrieved using the reference identifier for the credential or the token. In yet other cases, the SRT server 30 can retrieve a token using the reference identifier, and can then detokenize the token to obtain the credential. The SRT server 30 may store a mapping between tokens and credentials in a database. In such cases, the SRT server 30 may be considered a wallet server, and the user device 20 can have a wallet application what works in conjunction with the wallet server.

In step S18, after receiving the authorization request message, the transport computer 40 transmits the authorization request message to the processing computer 50.

Although this example describes the SRT server 30 generating an authorization request message, in other embodiments, the SRT server 30 initiate the transmission of the authorizing request message by sending the information needed for an authorization request message to the transport computer 40. The transport computer 40 can then generate and transmit the authorization request message to the processing computer 50.

In step S20, after the processing computer 50 receives the authorization request message from the transport computer 40, the processing computer 50 parses the authorization request message to determine the credential or the token. If the authorization request message comprises the credential, then the processing computer 50 can analyze the credential (e.g., a PAN or primary account number) to determine an authorizing entity identifier (e.g., a BIN or bank identification number). If the authorization request message comprises the token, then the processing computer 50 can de-tokenize the token to obtain the credential, and the authorizing entity identifier can be determined as noted above. The processing computer 50 may store a mapping between tokens and credentials in a database. After determining the appropriate authorizing entity computer 60, the processing computer 50 transmits the authorization request message to the authorizing entity computer 60.

After receiving the authorization request message, the authorizing entity computer 60 can decide whether to authorize the transaction. For example, the authorizing entity computer 60 can manage an account associated with the credential and can determine if there are sufficient funds in the account to pay for the transaction. The authorizing entity computer 60 can also analyze the account activity and the transaction details to determine if the transaction is potentially fraudulent. After making the determination of whether to authorize the transaction, the authorizing entity computer 60 can generate an authorization response message. The authorization response message may comprise the credential, the energy supplier identifier, the session ID, and an authorization indicator (e.g., whether the transaction is approved or declined).

In step S22, the authorizing entity computer 60 transmits an authorization response message to the processing computer 50.

In step S24, after receiving the authorization response message, the processing computer 50 transmits the authorization response message to the transport computer 40.

In step S26, the transport computer 40 transmits the authorization response message to the terminal support computer 70.

In step S28, the terminal support computer 70 transmits a notification such as an indicator message comprising the authorization indicator indicating that the transaction was authorized and the session ID to the energy supply terminal 80. After receiving this information, the energy supply terminal 80 can determine that the received session ID matches the previously generated session ID from step S10, and that the authorization indicator indicates that the energy supply terminal 80 can supply energy to the vehicle 10. The energy supply terminal 80 can the provide the energy to the vehicle 10. The energy supply terminal 80 may be programmed to provide energy to the vehicle 10 corresponding to the authorized amount of the transaction.

In step S30, a payment approved message is transmitted by the transport computer 40 to the SRT server 30. The payment approved message can be a message indicating authorization of the transaction. In some embodiments, the message indicating authorization of the transaction can be the authorization response message.

In step S32, the SRT server 30 transmits the payment approved message to the user device 20. Note that steps S30-S32 can occur before or concurrently with steps S26-S28 in other embodiments.

In some embodiments, the transport computer 40 can generate a signed response (signed with a transport computer 40 private key) for the energy supply terminal 80, and this can be communicated to the energy supply terminal 80 either via the SRT server 30, the user device 20, and the vehicle 10 (without any message from the terminal support computer 70). The energy supply terminal 80 can then verify the signed response (e.g., with a transport computer 40 public key) from transport computer 40, and can provide the energy to the vehicle 10 in response to the verification. In such embodiments, the energy supply terminal 80 does not need to have a network connection (e.g., to the terminal support computer 70), and can supply energy to the vehicle 10.

At the end of the day or at some other period of time, a clearing and settlement process can take place between the transport computer 40, the processing computer 50, and the authorizing entity computer 60. In some embodiments, the clearing process can include clearing messages that can include final amounts of energy dispensed, which may be different from original estimated amounts.

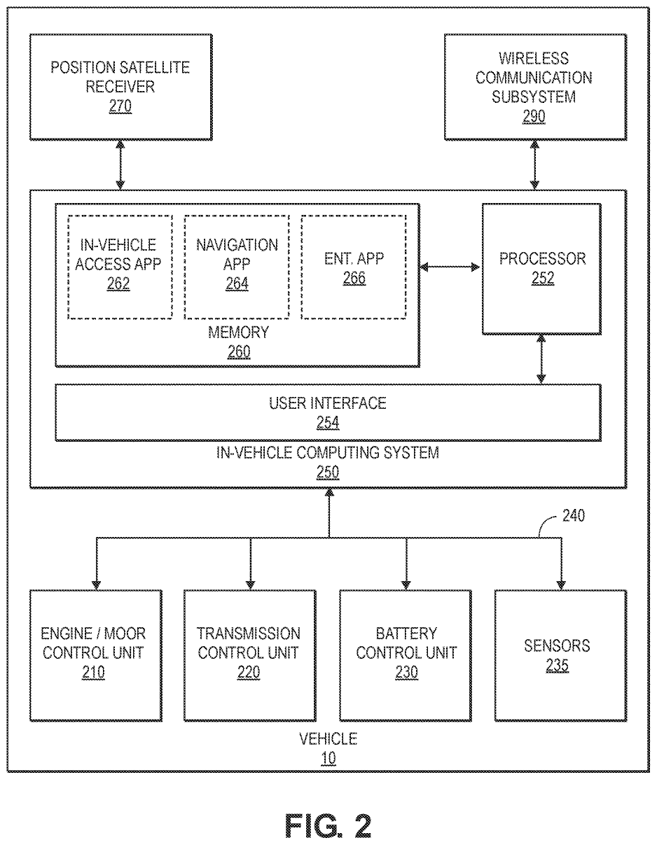

FIG. 2 illustrates a block diagram of a vehicle 10, according to some embodiments. Vehicle 10 can be powered by a gasoline engine, an electric or hybrid-electric engine, a fuel cell, or other types of motor engines or energy sources. Although vehicle 10 may be described as an automobile, it should be understood that in some embodiments, the techniques described herein can also be applied to other types of vehicles such as motorcycles, boats, aircrafts, or other types of powered machines that are used to transport a user from one location to another.

Vehicle 10 may include various electronic control units (ECUs) to operate and control the electrical system or other subsystems of vehicle 10, and may include sensors 235 that the ECUs can monitor. Each ECU may include a microcontroller and one or more memories (e.g., any combination of SRAM, EEPROM, Flash memories, etc.) to store one or more executable programs for the ECU. Examples of ECUs may include engine/motor control unit 210, transmission control unit 220, and battery control unit 230, etc. In some embodiments, vehicle 10 may include additional ECU(s) not specifically shown, omit one or more ECUs, and/or integrate any of the functionalities of different ECUs into a single ECU.

Engine/motor control unit 210 may control the actuators, valves, motor, and/or other components of the engine of vehicle 10, or an electric motor of the vehicle 10. Transmission control unit 220 may control the gear shifting and the transmission modes (e.g., park, drive, neutral, reverse) of vehicle 200. Battery control unit 230 may control the electrical voltage and current supplied by a battery to the various components of vehicle 10. Sensors 235 may include vehicle speed sensors (e.g., wheel sensors) to detect the speed of vehicle 10, temperature sensors to detect the operating temperature of the vehicle's various components, air sensors to detect oxygen level in the engine, sensors to detect the amount of energy currently (e.g., electricity, gas, etc.) present with the vehicle, cameras to observe the surroundings of vehicle 10, etc. The various ECUs and sensors may communicate with one another via a vehicle communication bus 240. Examples of vehicle communication bus 240 may include a controller area network (CAN) bus, a local interconnect network (LIN) bus, a vehicle area network (VAN) bus, or other suitable signal buses for vehicle communication.

Vehicle 10 may also include various radio frequency (RF) transceivers to allow vehicle 10 to receive and transmit RF signals with other devices. For example, vehicle 10 may include a positioning satellite receiver 270 such as a GPS receiver to receive satellite signals that can be demodulated and decoded to determine the location of vehicle 10. The positioning satellite receiver 270 can be used by a positioning or navigation subsystem of vehicle 10 to perform routing and mapping functions.

Vehicle 10 may also include a wireless communication subsystem 290 to enable network connectivity for vehicle 10. Wireless communication subsystem 290 may include one or more wireless transceivers that use WiFi, WiMax, or other types of wireless network communication protocols to connect vehicle 10 to an external network (e.g., the Internet) such that vehicle 10 can communicate with remote servers. Wireless communication subsystem 290 may also include one or more short or near range wireless transceivers such as RFID, Bluetooth or Bluetooth Low Energy, NFC, beacon, infrared transmitters and/or receivers that can be used to communicate with an access device in proximity to vehicle 10.

Vehicle 10 may also include an in-vehicle computing system 250 with which a user of vehicle 10 can interact. In-vehicle computing system 250 can be an infosystem, infotainment system, or other instrumentation system. In-vehicle computing system 250 can be mounted in the center console, dashboard, rear console, or other locations in vehicle 200 that is convenient for a user to access in-vehicle computing system 250. In some embodiments, in-vehicle computing system 250 can be coupled to vehicle communication bus 240 to receive vehicle status information from the ECUs and sensors 235.

In-vehicle computing system 250 may include a processor 252, a memory 260, and user interface 254. User interface 254 may include an input interface such as any number of buttons, knobs, microphone and/or a touchscreen that can receive user input, and an output interface such as a display (may be part of a touchscreen) and/or speakers. The display of user interface 254 can be integrated with the housing of in-vehicle computing system 250, or can be a separate component coupled to in-vehicle computing system 250 but mounted at a different location than in-vehicle computing system 250. For example, the display of user interface 254 can be mounted on the surface of the center console, on the dashboard, on the surface of the rear console, behind the headrest, on the interior ceiling, on the visor, or other suitable location in vehicle, and may display various types of information including information such as vehicle status information (e.g., speed, fuel economy, engine temperature, etc.), environmental information (e.g., inside/outside temperature, weather, etc.), navigation information (e.g., maps, routes, places of interests, etc.), entertainment such as videos or titles of audio selections or radio stations, energy level information (e.g., amount of charge present and needed to fill to capacity, amount of gas present and needed to fill to capacity), transaction information, energy terminal information, etc.

Memory 260 may include any combination of SRAM, DRAM, EEPROM, Flash, and/or other types of memories, etc. Memory 260 may store a number of applications such as in-vehicle access application 262, navigation application 264, entertainment application 266, and/or other applications not specifically shown such as a climate control application. Entertainment application 266 may provide a user of vehicle 10 with video and/or audio entertainment. For example, entertainment application 266 can play a movie on user interface 254, play an audio track via user interface 254, or allow a user to tune to a radio station.

Navigation application 264 can be part of a positioning or navigation subsystem of vehicle 10, and may provide navigation functionalities such as mapping and routing functions. A user of vehicle 10 may input a desired location into in-vehicle computing system 250, and navigation application 264 can determine a current location of vehicle 10 using a positioning satellite receive 270, and provide directions to travel to the desired location. Navigation application 264 may display a map on user interface 254 and highlight a route to a desired destination. Navigation application 264 may also display nearby places of interests and/or nearby merchants on user interface 254.

In-vehicle access application 262 enables in-vehicle computing system 250 to interact with user device or an SRT server. In some scenarios, in-vehicle access application 262 may allow a user of vehicle 10 to execute a transaction with the access device without requiring the user to exit vehicle 10, and without requiring the user to use another device such as the user's payment card or mobile device. In-vehicle access application 262 may store account credentials or tokens, or reference identifiers thereof for various accounts, allow a user to select a particular account, and transmit the account credentials or tokens (or references identifiers thereof) associated with the selected account to a user device and/or SRT server upon approval by the user.

The memory 260 can comprise a computer readable medium. The computer readable medium may comprise code, executable by the processor 252 to perform a method comprising: receiving from an energy supply terminal, transaction data comprising an energy provider identifier for a transaction to provide energy from the energy supply terminal to a vehicle; determining a credential; transmitting to a secure remote transaction server, the energy provider identifier and a selection of the credential, wherein the secure remote transaction server initiates transmission of an authorization request message comprising the energy provider identifier, the credential or a token corresponding to the credential, and an amount; and receiving, from the secure remote transaction server, a message indicating authorization for the transaction.

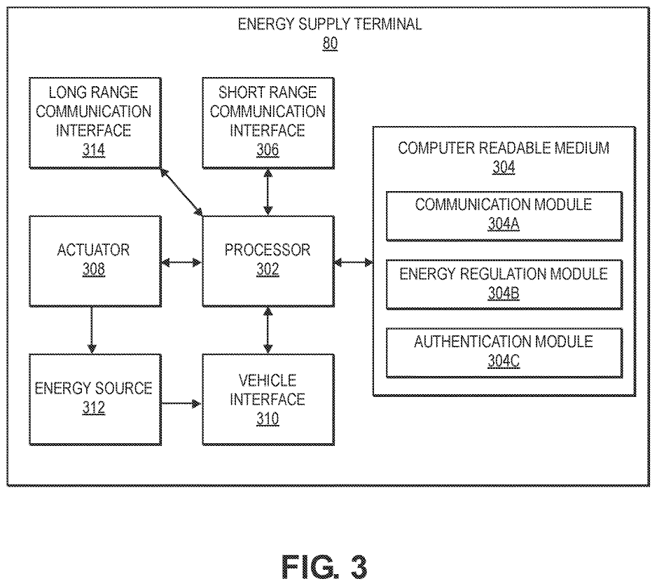

FIG. 3 shows a block diagram of an energy supply terminal 80 according to an embodiment. The energy supply terminal 80 can comprise a processor 302. The energy supply terminal may also comprise a computer readable medium 304, a short range communication interface 306, an actuator 308, a vehicle interface 310, and a long range communication interface 314 coupled to the processor 302. An energy source 312 can be coupled to the actuator 308 and the vehicle interface 310. The actuator 308 may be a pump or switch (e.g., an electrical or mechanical switch) that allows the energy source 312 to provide energy to the vehicle interface 310 and then to a connected vehicle. The energy source 312 could be an electrical line or conduit, or it could be a fuel tank.

The computer readable medium 304 may further comprises a communication module 304A, an energy regulation module 304B, and an authentication module 304C. The communication module 304A can include code, executable by the processor 302 to allow the energy supply terminal 80 to communicate with external devices such as a vehicle or remote computer such as the previously described terminal support computer 70. The energy regulation module 304B and the processor 302 can determine how much energy is needed or should be provided to a vehicle, and can control the actuator 308 to control the flow of energy to the vehicle interface 310 and to the connected vehicle. The authentication module 304C can be used to authenticate a user and/or a vehicle that may be connected to the energy supply terminal 80.

The computer readable medium 304 may further comprise code, executable by the processor 302 to perform a method comprising: providing, by an energy supply terminal to a vehicle, transaction data comprising an energy provider identifier for a transaction to provide energy from the energy supply terminal to the vehicle, which provides the transaction data to a user device, and then to a secure remote transaction server, wherein the secure remote transaction server initiates transmission of an authorization request message comprising the energy provider identifier, a credential or a token corresponding to the credential, and an amount; receiving, by the energy supply terminal, an indicator message from a terminal support computer after the secure remote transaction server initiates the transmission of the authorization request message; and responsive to receiving the indicator message, providing the energy to the vehicle

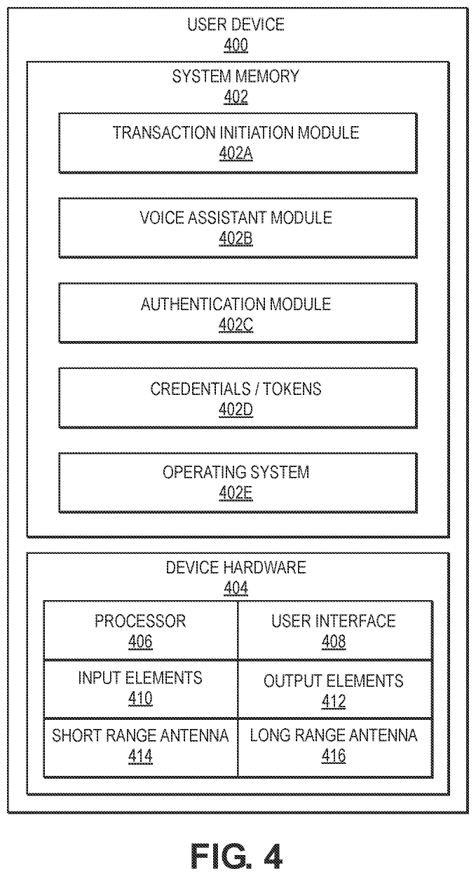

FIG. 4 shows a block diagram of a user device 400 in according to an embodiment. The user device 400 may include device hardware 404 coupled to a system memory 402.

Device hardware 404 may include a processor 406, a short range antenna 414, a long range antenna 416, input elements 410, a user interface 408, and output elements 412 (which may be part of the user interface 408). Examples of input elements may include microphones, keypads, touchscreens, sensors, etc. Examples of output elements may include speakers, display screens, and tactile devices.

The long range antenna 416 may include one or more RF transceivers and/or connectors that can be used by user device 400 to communicate with other devices and/or to connect with external networks. The user interface 408 can include any combination of input and output elements to allow a user to interact with and invoke the functionalities of user device 400. The short range antenna 409 may be configured to communicate with external entities through a short range communication medium (e.g., using Bluetooth, Wi-Fi, infrared, NFC, etc.). The long range antenna 819 may be configured to communicate with a remote base station and a remote cellular or data network, over the air.

The system memory 402 can be implemented using any combination of any number of non-volatile memories (e.g., flash memory) and volatile memories (e.g., DRAM, SRAM), or any other non-transitory storage medium, or a combination thereof media.

The system memory 402 may also store a transaction initiation module 402A, a voice assistant module 402B, an authentication module 402C, credentials and/or tokens 402D, and an operating system 402E, The transaction initiation module 402A may include instructions or code initiating and conducting a transaction with an external device such as an access device or a processing computer. It may include code, executable by the processor 406, for generating and transmitting authorization request messages, as well as receiving and forwarding authorization response messages. It may also include code, executable by the processor 406, for forming a local connection or otherwise interacting with an external device (e.g., an SRT server). The voice assistant module 402B may comprise code, executable by the processor 406, to receive voice segments, and generate and analyze data corresponding to the voice segments. The authentication module 402C may comprise code, executable by the processor 406, to authenticate a user. This can be performed using user secrets (e.g., passwords) or user biometrics. System memory 402 may also store credentials and/or tokens or references to credentials and/or tokens 402D.

The system memory 402 can comprises a computer readable medium. The computer readable medium comprises code, executable by the processor 406 to implement a method comprising: receiving, from an energy supply terminal, transaction data comprising an energy provider identifier for a transaction to provide energy from the energy supply terminal to a vehicle; determining a credential; transmitting, to a secure remote transaction server, the energy provider identifier and a selection of the credential, wherein the secure remote transaction server initiates transmission of an authorization request message comprising the energy provider identifier, the credential or a token corresponding to the credential, and an amount; and receiving, from the secure remote transaction server, message indicating authorization for the transaction.

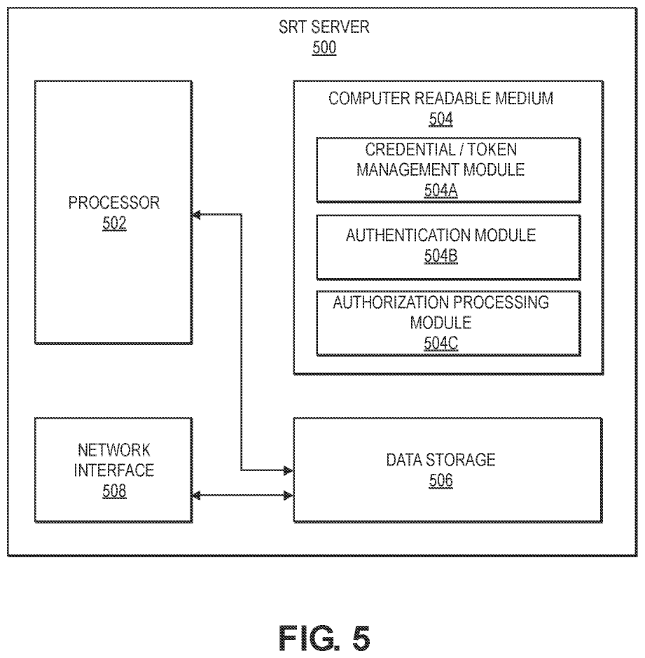

FIG. 5 shows a block diagram of an SRT server 500 according to an embodiment. The SRT server 500 can comprise a processor 502, which may be coupled to a data storage 506 and a network interface 508. A computer readable medium 504 may also be operatively coupled to the processor 502. The data storage 506 can store any suitable data including but not limited to credentials and/or tokens, references to credentials and/or tokens, user data (e.g., usernames) or vehicle data (e.g., VINs) associated with the credentials or tokens, etc.

The computer readable medium 504 may comprise a number of software modules including a credential/token management module 504A, an authentication module 504B, and an authorization processing module 504C.

The credential/token management module 504A may comprise code that causes the processor 502 to retrieve credentials or tokens from the data storage 506 in response to receiving credential or token identifiers. The credential/token management module 504A may also comprise code that causes the processor 502 to receive and store credentials and/or tokens in the data storage 506.

The authentication module 504B may comprise code that causes the processor 502 to authenticate users, user devices, or vehicles used by users, before processing transactions.

The authorization processing module 504C may comprise code that causes the processor 502 to perform authorization processing. Authorization processing can include generating and transmitting authorization request messages or providing instructions to generate and transmit authorization request messages, receiving authorization response messages, and generating notifications relating to transaction authorizations or declines. Authorizing processing can also including gathering data for an authorization and transmitting it to another computer.

Embodiments of the invention have a number of technical improvements and advantages. As noted above, transactions to supply energy to vehicles can be performed without providing sensitive data such as credentials and tokens to energy supply terminals or terminal support computers operated by energy supply organizations. Further, since credentials or tokens are not provided to energy supply terminals, the energy supply terminals do not need to be specifically programmed and maintained to accept different types of payment devices, and also need not be PCI-DSS compliant. Still further, using some embodiments of the invention, electric charging stations need not have specialized payment hardware and software, or even network connections, to allow users to charge their vehicles and pay for their charging transactions.

Any of the software components or functions described in this application, may be implemented as software code to be executed by a processor using any suitable computer language such as, for example, Java, C++, or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed:

1. A method comprising:
receiving, by a user device from an energy supply terminal, transaction data comprising an energy provider identifier for a transaction to provide energy from the energy supply terminal to a vehicle;
determining, using the user device, a credential;
transmitting, by the user device to a secure remote transaction server, the energy provider identifier, and a selection of the credential, wherein the secure remote transaction server initiates transmission of an authorization request message comprising the energy provider identifier, the credential or a token corresponding to the credential, and an amount; and
receiving, by the user device from the secure remote transaction server, a message indicating authorization for the transaction.

2. The method of claim 1, wherein the energy comprises electricity, the energy supply terminal is an electricity supply terminal and the energy provider identifier is an electricity provider identifier.

3. The method of claim 1, wherein the user device receives the transaction data from the energy supply terminal via the vehicle.

4. The method of claim 1, The method of claim 1, wherein the user device is part of the vehicle.

5. The method of claim 1, wherein the vehicle is a car.

6. The method of claim 1, wherein the selection of the credential includes the credential.

7. The method of claim 1, wherein the selection of the credential includes an identifier for the credential, wherein the credential is stored by the secure remote transaction server.

8. The method of claim 1, wherein the user device receives the transaction data from the energy supply terminal via the vehicle, wherein the vehicle is temporarily connected to the energy supply terminal via a charging cable.

9. The method of claim 8, wherein the vehicle and the energy supply terminal communicate through the charging cable using ISO 15118.

10. The method of claim 1, wherein the secure remote transaction server initiates transmission of the authorization request message by generating the authorization request message and transmitting the authorization request message to an authorizing entity computer.

11. The method of claim 1, wherein the secure remote transaction server initiates transmission of the authorization request message by providing the transaction data to a transport computer which generates the authorization request message and transmits the authorization request message to an authorizing entity computer via a processing computer.

12. The method of claim 11, message indicating authorization is signed by the transport computer, and is transmitted by the user device to the energy supply terminal, which verifies the signed message indicating authorization.

13. The method of claim 1, wherein the user device receives the transaction data from the energy supply terminal via the vehicle, wherein the vehicle provides the transaction data to the user device.

14. The method of claim 1, wherein the transaction data is provided from the vehicle to the user device via a short-range wireless communication medium, or via a machine readable code.

15. A user device comprising:
a processor; and
a non-transitory computer readable medium, the non-transitory computer readable medium comprising code, executable by the processor for performing operations comprising:
receiving, from an energy supply terminal, transaction data comprising an energy provider identifier for a transaction to provide energy from the energy supply terminal to a vehicle;
determining a credential;
transmitting, to a secure remote transaction server, the energy provider identifier, and a selection of the credential, wherein the secure remote transaction server initiates transmission of an authorization request message comprising the energy provider identifier, the credential or a token corresponding to the credential, and an amount; and
receiving, from the secure remote transaction server, a message indicating authorization of the transaction.

16. A method comprising:
providing, by an energy supply terminal to a vehicle, transaction data comprising an energy provider identifier for a transaction to provide energy from the energy supply terminal to the vehicle, which provides the transaction data to a user device, and then to a secure remote transaction server, wherein the secure remote transaction server initiates transmission of an authorization request message comprising the energy provider identifier, a credential or a token corresponding to the credential, and an amount;
receiving, by the energy supply terminal, an indicator message after the secure remote transaction server initiates the transmission of the authorization request message; and
responsive to receiving the indicator message, providing the energy to the vehicle.

17. The method of claim 16, wherein the vehicle is car.

18. The method of claim 17, wherein the energy supply terminal is temporarily connected to the vehicle using a charging cable, and the transaction data and the energy are provided to the vehicle using the charging cable.

19. The method of claim 16, wherein the energy is electricity.

20. The method of claim 16, wherein the indicator message is received from a terminal support computer in communication with the SRT server.
